(19) United States
(12) Patent Application Publication
(10) Pub. No.: US 2023/0322622 A1
(43) Pub. Date: Oct. 12, 2023

(54) METHOD FOR THE TREATMENT OF NON-HARDENED CEMENT COMPOSITIONS, ADMIXTURE TO BE USED IN SUCH METHOD, AND USE OF SOLID GRANULES PRODUCED BY SUCH METHOD

(71) Applicant: SIKA TECHNOLOGY AG, Baar (CH)

(72) Inventors: Ana JIMENEZ, Rutherford, NJ (US); Svetlana LEVITINA, Brooklyn, NY (US); Kyle GOLDHAMMER, Pompton Lakes, NJ (US)

(73) Assignee: SIKA TECHNOLOGY AG, Baar (CH)

(21) Appl. No.: 17/704,695

(22) Filed: Mar. 25, 2022

(51) Int. Cl. C04B 18/16; C04B 24/26; C04B 24/10; C04B 18/02

(52) U.S. Cl. CPC C04B 18/167; C04B 18/021; C04B 24/10; C04B 24/2694

(57) ABSTRACT

Methods for the treatment of non-hardened cement compositions, especially returned concrete, and admixtures suitable to be used in such methods. The admixtures include modified starch and a sugar. Also, solid granules obtained by the methods and fresh concrete or mortar utilizing solid granules thus obtained.

### TECHNICAL FIELD

The present invention relates to a method for the treatment of non-hardened cement compositions, especially returned concrete. Non-hardened cement compositions are coagulated and dried to form solid granules in methods of the present invention, thereby resulting in granular re-usable material. The present invention may particularly be used to process non-hardened residual concrete or mortar which may be left over after a work order has been completed or which is off-spec. The present invention also relates to admixtures to be used in such methods and to the use of solid granules produced by such method

### BACKGROUND OF THE INVENTION

It is estimated that 1% of any concrete produced cannot be used in the way originally intended. For example, the delivered quantity may exceed the demand or the quality of concrete produced does not meet the specifications. The result is that the concrete produced is not usable in the intended application. Such concrete is normally returned to the concrete factory where it may be put to further use or is reprocessed in a variety of ways. For example, standard elements may be made, or the concrete can be spread out, reground after hardening, and then used again. It is also possible to wash the concrete with water, in which process the non-reactive components such as sand are separated from the cement paste. These components may then be reused to produce fresh concrete.

However, the production of standard concrete elements, for example, the need for such elements does not always exist. The regrinding of hardened concrete requires a large amount of energy and at the same time a considerable amount of dust and noise is generated. This makes the processing of returned concrete rather unattractive.

It has also been proposed to coagulate returned concrete to form solid granules. To this end, admixtures are added to the returned concrete while still wet. These admixtures transform wet concrete into hard granules which, for example, can be reused as an aggregate for fresh concrete. Suitable admixtures are added directly to the truck mixer containing the returned concrete. Typical admixtures absorb free water from the returned concrete and swell, thereby forming agglomerates which incorporate the cement and the finer fractions of the mix. With the rotation of the truck mixer drum, these agglomerates cover the coarser aggregates and form a layer of variable thickness. The result is that the returned concrete is coagulated and transformed into a multitude of granules of varying sizes, each formed by aggregates that constitute the central core and an outer coating formed by the agglomerates. The fresh coagulated material are sufficiently compact to be accumulated and stored to complete the cement hydration and hardening reactions. Once hardened, the granular material produced from the returned concrete can be, for example, reused as roadbed material or as a recycled aggregate to produce fresh concrete, partly or wholly replacing fresh aggregates.

For example, WO 2012/084716 describes a method for producing a granulate from returned concrete, comprising adding a flash setting accelerator and a superabsorbent polymer to a wet cement composition. However, this method frequently has the problem of stickiness of granules obtained.

WO 2016/071298 describes a method for producing a granulate from returned concrete, comprising adding a water-absorbing agent and a crystallization deactivator to a wet cement composition, and mixing until a granular material has formed. The water-absorbing agents include super-absorbent polymers, which may be natural or synthetic, and phyllosilicates, in particular vermiculite. The crystallization deactivators cited include lactic acid, citric acid and malic acid.

US 2018/0162774 relates to a method to produce aggregates from unsettled cementitious mixtures. Pelletizing agents selected from the group consisting of cellulose, chitosan, collagen, polyacrylamide and co-polymers of polyacrylamide and polyacrylics, polyamines, polyvinylalcohols, polysaccharides, lactic acid, methacrylic acid, methacrylate, hydroxyethyl, ethylene glycol, ethylene oxide, acrylic acid, inorganic flocculants and inorganic coagulants are disclosed. Unfortunately, the US 2018/0162774 does not elaborate on optimization of the pelletizing agent.

US 2020/0094263 also relates to a method for producing aggregates from returned concrete. It is suggested to add organic or inorganic flocculants to the returned concrete, which organic flocculants can consist of anionic and cationic polyelectrolytes or high-molecular-weight polysaccharides such as cellulose and derivatives thereof and starch and derivatives thereof. Also, the US 2020/0094263 does not elaborate on optimization of the flocculants.

There exists thus still a need for optimized methods for the treatment of non-hardened cement compositions, especially returned concrete, and also for admixtures that can be used in such methods.

### SUMMARY OF THE INVENTION

A first objective of the present invention is to provide methods for the treatment of non-hardened cement compositions, especially returned concrete. Another objective of the present invention is to provide admixtures suitable to be used in a method for the treatment of non-hardened cement compositions, especially returned concrete. Especially such methods and admixtures should be useful for many different types of returned concrete, in particular for many different types of Portland cement used to make such returned concrete.

These and other objectives have surprisingly been solved in a particularly efficient manner by an admixture comprising modified starch and a sugar and by a method employing such admixture. These are the subject matter of independent claims.

Advantages of an admixture of the present invention in particular are that
(i) it efficiently dries non-hardened cement compositions, especially returned concrete,
(ii) it leads to solid granules of low strength which can be easily handled, especially with low EHS risks and lower energy consumption,
(iii) it maintains its performance even when overdosed,
(iv) it leaves no residue of treated concrete in the mixing vessel.

Further aspects of the present invention are the subject matter of further independent claims. Preferred embodiments of the present invention are the subject matter of dependent claims.

### WAYS FOR CARRYING OUT THE INVENTION

In a first aspect the present invention relates to a method for the treatment of non-hardened cement compositions, especially returned concrete, said method comprising the steps of:
a) providing a non-hardened cement composition, especially returned concrete,
b) providing an admixture which comprises a modified starch and a sugar,
c) mixing said non-hardened cement compositions and said admixture to form a coagulated material,
d) discharging the coagulated material obtained under c) into a storage facility,
e) drying said coagulated material to form solid granules, and
f) optionally separating said dried, solid granules into fractions of different particle size.

Solid granules produced by a method of the present invention may, for example, be used as recycled aggregates. This is because such solid granules are based on material which has been used before, are retrieved by a method of the present invention, and can be put to re-use as aggregates.

A returned concrete within the present context is meant to describe non-hardened cement compositions which have not been used as intended and must therefore be recycled.

A non-hardened cement composition, especially returned concrete, within the present context is a slurry of cement, aggregates, and optionally additives and/or admixtures in water. Especially, a returned concrete is a concrete or mortar which has been mixed up with water but has not set or hardened. A returned concrete thus is in a wet state. The amount of any of cement, aggregates, additives, admixtures, and water in a returned concrete may vary within the ratios typically encountered in concretes and mortars. Mixtures of different cements, for example Portland cement and aluminate cement, and/or of aggregates of different chemistry and/or particle size may be present. A non-hardened cement composition, especially returned concrete, can especially be surplus material or off-spec material. A non-hardened cement composition, especially returned concrete, need to be transported from a production site to a recycling site but may also be material which is to be recycled at the place of production, for example because it is off-spec.

A method of the present invention is effective for any type of non-hardened cementitious mixture, including returned concrete or mortar or any type of concrete or mortar that, for any reason, cannot be used but is still fluid and has not yet completely set. Examples of concrete that cannot be placed and therefore can be used in this invention are superfluous concrete that has not been used at the job site, mortars or concretes that have a wrong mix design and therefore are not used or concrete or mortars that have lost their properties due to a poor mix design.

According to embodiments, a returned concrete has a slump class of S1, S2, S3, S4 or S5 or a flow class of F1, F2, F3, F4, F5, or F6 according to tables 3 and 6 of standard EN 206-1:2000.

It is especially preferred that a returned concrete of the present invention comprises Portland cement, aggregates, and water with a weight ratio of water to cement of between 0.2 - 0.9. Portland Cement is of type I to type V as described in standard ASTM 150-00 or is of type CEM I according to standard EN 197-1. Of course, Portland cement which is according to other national standards, such as Japanese, Chinese, or Indian standards, are also encompassed.

The admixture provided in step b) comprises a modified starch and a sugar. The admixture may comprise additional materials, especially water, filler, biocide, pigment, cement accelerator, cement retarder, plasticizer, superplasticizer, rheology modifying agent, or mixtures thereof. Suitable fillers preferably are calcium carbonate or magnesium carbonate based fillers. Suitable cement accelerators preferably are alkanolamines, aluminum sulfate, aluminum hydroxide, silicates, as well as alkali metal or alkaline earth metal hydroxide, hydrogen carbonate, sulphate, nitrate, nitrite, or thiosulphate. Suitable cement retarders preferably are hydroxy-carboxylic acids or borates.

It is, however, preferred that the admixture provided in step b) of a method of the present invention essentially consists of a modified starch and a sugar.

According to embodiments, the admixture provided in step b) of a method of the present invention essentially consists of 70 - 80 w% of modified starch and 20 - 30 w% of a sugar.

A modified starch within the present context is a material derived from natural or synthetic starch, preferably from natural starch. Natural starch is not particularly limited and may be, for example, potato starch, corn starch, pea starch, rice starch, or wheat starch. Modified starch is prepared by physically, enzymatically, or chemically treating native starch to change its properties. Modified starches useful for the present invention include dextrins, alkaline-modified starch, bleached starch, oxidized starch, enzyme-treated starch, phosphate starch, acetylated starch, starch ethers such as hydroxypropylated starch or hydroxyethyl starch, carboxymethylated starch and co-polymers of starch and organic monomers. The term modified starch does not include native starch and also does not include biopolymers different from modified starch. Especially the term modified starch does not include cellulose or modified celluloses.

A very preferable modification of starch is grafting starch with organic monomers. Suitable organic monomers are ehtylenically unsaturated monomers such as styrene, butadiene, (meth)acrylic acid, esters of (meth)acrylic acid, (meth)acrylamide, acrylonitrile, vinylchloride, esters of vinylacohol such as vinylacetate or vinylversatate. Preferably, such modified starch is prepared by grafting from the native starch and using ehtylenically unsaturated monomers. The grafting can be started, for example, by production of radicals on the starch by irradiation or the effect of suitable radical initiators (“grafting from”). Grafting can also be effected by ring-opening polymerization (“grafting from”), polycondensation (“grafting from”), or esterification (“grafting to”) and using different monomers or polymers as grafting agents. Suitable processes are described in the article “Modification of starch by graft copolymerization” by J. Meimoun et al (Wiley-VCH, Starch/Stärke, Vol 70, 2018). Modified starch obtained in such processes may contain starch granules covered with a layer of graft copolymer or may contain crosslinked network structures or aggregates. The degree of grafting and degree of crosslinking can be adjusted by careful control of the polymerization reaction.

According to a very preferably embodiment of the present invention, the modified starch is a copolymer of starch grafted with acrylic acid and acrylamide. It is preferred, within the present context, that the modified starch is a crosslinked network of starch grafted with ehtylenically unsaturated monomers, especially acrylic acid and acrylamide.

The copolymer of starch grafted with acidic functionalities, especially the copolymer of starch grafted with acrylic acid and acrylamide, can be neutralized in part or fully with alkali metal or alkaline earth metal bases, especially with sodium hydroxide, potassium hydroxide, or calcium hydroxide.

A sugar within the present context is a carbohydrate with at least 6 C-atoms. Suitable sugars especially are hexoses of the aldose or ketose type. Suitable sugars are allose, altrose, glucose, manose, gulose, idose, galactose, tallose, and fructose. Other suitable sugars are dimers of hexoses, especially dimers of allose, altrose, glucose, manose, gulose, idose, galactose, tallose, and fructose. Suitable dimers of hexoses especially are cellobiose, isomaltose, isomaltulose, lactose, lactulose, maltose, maltulose, melobiose, and sucrose.

According to especially preferred embodiments of the present invention the sugar is sucrose. However, any of the sugars as recited above will suffice.

A non-hardened cement composition, especially returned concrete, in step a) of a method of the present invention is most typically provided in a concrete mixer truck. It may, however, also be provided in any other device suitable for mixing of concrete. Mixing devices include but are not limited to the rotary drum of a traditional concrete truck, paddle mixers, disc pelletizers, drum pelletizers, pin mixer agglomerators, ribbon blenders, planetary mixer, Hobart mixer, portable concrete mixer, mixing bucket, jet mixer, screw mixer, auger mixer, horizontal single shaft mixer, vertical shaft mixer, ribbon blender, and orbiting mixer. Mixing devices suitable for intensive mixing are preferred.

The admixture in step b) of a method of the present invention may be provided as a mono-component admixture or as a multi-component, especially a two-component admixture. A mono-component admixture contains all ingredients of the admixture in one container. A multi-component admixture contains the ingredients of the admixture in multiple, preferably in two, spatially separated containers. It is thus possible, in step b) of a method of the present invention to provide all ingredients of the admixture at once. This means, that all ingredients of the admixture are added to the non-hardened cement compositions, especially returned concrete, at once. This is typically preferred. It is, however, also possible to first add the modified starch to the non-hardened cement compositions, especially returned concrete, and then add the sugar at a later point of time.

An admixture of the present invention may be dosed in a range of 0.5 - 5 kg/m³ of non-hardened cement compositions, especially returned concrete, preferably 1 - 3.5 kg/m³. For example, a returned concrete with higher fluidity will need a higher amount of admixture. It has been found that an admixture of the present invention is effective also in cases where the non-hardened cement compositions, especially returned concrete, contains a high amount of water. A high amount of water is water in a weight ratio of water to cement of more than 0.6 and may be as high as 0.8 or 0.9.

The mixing of non-hardened cement compositions, especially returned concrete, and the admixture as described above in step c) of a method of the present invention may be done in any of the mixing devices described above or in any other mixing device suitable for intensive mixing.

According to a particularly preferred embodiment of the present invention, the mixing in step c) is done in the rotary drum of a traditional concrete truck. It is, for example, possible to add the admixture of the present invention to a returned concrete into the rotary drum of a traditional concrete truck at a building site. Mixing may then take place while the concrete truck drives back to a plant and returned concrete has coagulated upon arrival at the plant. It is likewise possible to add the admixture of the present invention to a returned concrete into the rotary drum of a traditional concrete truck at a plant, for example the concrete batching facility. It is also possible that returned concrete is discharged from the concrete truck and into a mixing device, especially a mixing device as described above, at a plant, for example at a concrete batching facility.

Mixing time needed in step c) of a method of the present invention depends on the type of non-hardened cement compositions, especially returned concrete, and the measured quantity of admixture.

The mixing time may range between 20 seconds and 15 minutes, preferably between 1 minute and 10 minutes, and most preferably between 2 minutes and 5 minutes. Shorter times do not allow the non-hardened cement compositions, especially returned concrete, to coagulate completely, whereas longer times are inefficient and may cause the mix to re-agglomerate.

When mixing the returned concrete with admixture of the present invention in the rotary drum of a concrete truck, the drum must be rotated at maximum speed for the duration of the mixing.

During step c) of a method of the present invention, the non-hardened cement compositions, especially returned concrete, forms coagulated material. Step c) can be finished when all non-hardened cement compositions, especially returned concrete, has coagulated.

The coagulated material produced may then be discharged from the mixer, especially from the rotary drum of the concrete mixing truck, and into a storage facility. The storage facility can be the ground and coagulated materials may be discharged to the ground to form a pile or a bed of material.

The coagulated material or the solid granules can be stored as other common aggregates for concrete.

The coagulated material is then dried in a step e) of a method of the present invention to form solid granules. The drying time needed depends on the conditions. Especially, the duration of the drying step has to be adjusted according to the temperature at which the coagulated material is being dried. Typical drying times are between 5 hours and 24 hours. Coagulated material may be dried under atmospheric pressure and at temperatures between -10° C. and + 100° C. The coagulated material may be air dried or using an oven, at any humidity and at a temperature not superior to 100° C. Very preferable are atmospheric pressure and a temperature between +5° C. and + 45° C.

Coagulated materials or solid granules can be exposed to precipitation, as long as they are left to dry thereafter. The coagulated material can also be sprayed or sprinkled with water, to avoid sudden water loss and cracking.

After the drying step e) of a method of the present invention the solid granules have gained sufficient mechanical strength to enable them to be transported to a storage area by a construction vehicle.

Solid granules of the present invention may be easily broken apart, for example by a front loader or a crusher.

A method of the present invention may optionally comprise a step of separating said dried, solid granules into fractions of different particle size.

According to embodiments, fractions of different particle size are fractions of 0.063 -4 mm, 4 - 8 mm, and 6 - 16 mm. Other fractions of different particle size are 0.063 -4 mm, 4 - 16 mm, and 16 - 32 mm. Still other fractions of different particle size are 0- 2 mm, 2 - 8 mm, 8 - 16 mm or 8 - 32 mm. Still other fractions of different particle size are 0 - 4 mm, 4 - 8 mm, 8 - 16 mm, 16 - 32 mm. Still other fractions of different particle size are 0.063 - 0.125 mm, 0.125 - 0.25 mm, and 0.25 - 0.355 mm. Still other fractions of different particle size are 0.08 - 0.16 mm, 0.16 - 0.50 mm, 0.50 -1.0 mm, 1.0 - 1.60 mm, and 1.60 - 2.0 mm. Still other fractions of different particle size are 63 - 300 µm, 100 - 600 µm, 500 - 1200 µm, 900 - 1500 µm.

According to embodiments, separation is done by filtration, sieving, sedimentation, density separation, centrifugation, and/or air sifting, e.g. in cyclones.

Separation can be done by sieving, for example with the use of common industrial vibration, rotary or cyclone sieves. Such separators are able to separate the solid granules on the basis of pre-selected particle size. The separators can be made of plastic or metal, with variable geometry and hole size. The quality of the separated material is further improved if an airstream in counter-current to the flow of solid granules in the sieve is blown in during the sieving process. The action of the air is designed to further dry the surface of the solid granules. The airflow can be produced by a ventilation system wherein the air can also be heated to facilitate drying of the material in the winter months and in cold climates.

According to embodiments, at the outlet of the size separation system, the fractions of different particle size produced are sent directly to the storage depots. The surface of the materials produced by the method according to the invention, typically those larger than 5 mm, are dry and can be directly stored with natural aggregates having the same particle-size characteristics. The fine fraction, smaller than 5 mm is sufficiently cohesive to be sent directly to the sand depot, wherein it is dispersed in the mass of material already stored. To improve handling in the fresh state before storage, the fine fraction just produced can optionally be mixed with a sufficient amount of dry sand or already hardened fine material, previously produced.

The method for the treatment of non-hardened cement compositions, especially returned concrete according to the invention can be conducted either discontinuously or continuously. The discontinuous process is particularly suitable for treating small amounts of non-hardened cement compositions, especially returned concrete. For larger amounts the continuous process is more advantageous.

According to embodiments, a method of the present invention may additionally comprise a step of crushing and/or grinding the solid granules.

A suitable crusher is for example a jaw crusher. Examples for suitable mills for grinding are vertical roller mills, a horizontal roller mills, ball mills or agitation mills.

According to further embodiments, the crushing and/or grinding is done under an atmosphere of CO₂.

Crushing and/or grinding the solid granules under an atmosphere of CO₂ will lead to carbonation of the cementitious material contained therein.

In particular, “carbonation” as used herein means the incorporation of carbon dioxide into chemical compounds or the chemical reaction of carbon dioxide with the parent material. Thus, “carbonation” specifically means a reaction of the starting material with carbon dioxide. For example, Portland cement consisting essentially of calcium, silicate and aluminum hydrates, can react with carbon dioxide to form corresponding carbonates.

The progressive carbonation can be measured by a drop in the pH value.

Carbonating the solid granular material enables binding of CO₂ from the surroundings and thus improves the environmental footprint of the solid granules. Additionally, it has been found that during grinding aggregates may be retrieved from the solid granular material in a particularly clean state, thus resembling fresh unused aggregates, when grinding is done under an atmosphere of CO₂. This is because the carbonated mineral binder is easier to be removed from the surface of aggregates.

It is possible to carbonate the solid granules prior and/or during the grinding step. It is, however, preferred that the carbonation takes place during the grinding step. This is because, the carbonated material will be removed from the aggregates during grinding more easily thereby releasing fresh, uncarbonated surfaces which can in turn be carbonated and removed more easily. The cleaning of aggregates is thus achieved very efficiently.

In another aspect, the present invention also relates to solid granules obtained in a method as described above. Within the present context, the term solid granule describes the dried granular material, optionally crushed and/or grinded, as described above. In other words, the term solid granules within the present context refers to the solid granules obtained in step e) or, if step f) is present, in step f), of a method of the present invention, or, if present, after additional crushing and grinding of dried solid granules. As explained above, solid granules obtained in a method of the present invention may, for example, be used as recycled aggregates.

Any embodiments and/or preferred features as described above also relate to this aspect.

Solid granules obtained in a method of the present invention may be used to prepare fresh concrete or mortar. It is possible to replace fresh aggregate, that is aggregate which has never been used before, by the solid granules of the present invention. Solid granules obtained in a method as described above may make up at least 30 w%, preferably at least 50 w%, more preferably at least 75 w%, still more preferably at least 90 w%, especially at least 99 w% of the total weight of aggregates in a concrete or mortar formulation.

The present invention thus also relates to a concrete or mortar mixture comprising at least one cement and aggregates, wherein at least 30 w%, preferably at least 50 w%, more preferably at least 75 w%, still more preferably at least 90 w%, especially at least 99 w% of the total weight of aggregates are solid granules obtained in a method of the present invention.

In yet another aspect, the present invention also relates to an admixture for use in a method for the treatment of non-hardened cement compositions, especially returned concrete, said admixture comprising
a) a modified starch, and
b) a sugar.

Any embodiments and/or preferred features as described above also relate to this aspect.

In particular, the admixture of the present invention essentially consists of a modified starch and a sugar, preferably essentially consists of 70 - 80 w% of modified starch and 20 - 30 w% of a sugar.

A modified starch within the present context is a material derived from natural or synthetic starch, preferably from natural starch. Natural starch is not particularly limited and may be, for example, potato starch, corn starch, pea starch, rice starch, or wheat starch. Modified starch are prepared by physically, enzymatically, or chemically treating native starch to change its properties. Modified starches useful for the present invention include dextrins, alkaline-modified starch, bleached starch, oxidized starch, enzyme-treated starch, phosphate starch, acetylated starch, starch ethers such as hydroxypropylated starch or hydroxyethyl starch, carboxymethylated starch and co-polymers of starch and organic monomers. The term modified starch does not include native starch and also does not include biopolymers different from modified starch. Especially the term modified starch does not include cellulose or modified celluloses.

A very preferable modification of starch is grafting starch with organic monomers. Suitable organic monomers are ehtylenically unsaturated monomers such as styrene, butadiene, (meth)acrylic acid, esters of (meth)acrylic acid, (meth)acrylamide, acrylonitrile, vinylchloride, esters of vinylacohol such as vinylacetate or vinylversatate. Preferably, such modified starch is prepared by grafting from the native starch and using ehtylenically unsaturated monomers. The grafting can be started, for example, by production of radicals on the starch by irradiation or the effect of suitable radical initiators (“grafting from”). Grafting can also be effected by ring-opening polymerization (“grafting from”), polycondensation (“grafting from”), or esterification (“grafting to”) and using different monomers or polymers as grafting agents. Suitable processes are described in the article “Modification of starch by graft copolymerization” by J. Meimoun et al (Wiley-VCH, Starch/Stärke, Vol 70, 2018). Modified starch obtained in such processes may contain starch granules covered with a layer of graft copolymer or may contain crosslinked network structures or aggregates. The degree of grafting and degree of crosslinking can be adjusted by careful control of the polymerization reaction.

According to a very preferably embodiment of the present invention, the modified starch is a copolymer of starch grafted with acrylic acid and acrylamide. It is preferred, within the present context, that the modified starch is a crosslinked network of starch grafted with ehtylenically unsaturated monomers, especially acrylic acid and acrylamide.

The copolymer of starch grafted with acidic functionalities, especially the copolymer of starch grafted with acrylic acid and acrylamide, can be neutralized in part or fully with alkali metal or alkaline earth metal bases, especially with sodium hydroxide, potassium hydroxide, or calcium hydroxide.

A sugar within the present context is a carbohydrate with at least 6 C-atoms. Suitable sugars especially are hexoses of the aldose or ketose type. Suitable sugars are allose, altrose, glucose, manose, gulose, idose, galactose, tallose, and fructose. Other suitable sugars are dimers of hexoses, especially dimers of allose, altrose, glucose, manose, gulose, idose, galactose, tallose, and fructose. Suitable dimers of hexoses especially are cellobiose, isomaltose, isomaltulose, lactose, lactulose, maltose, maltulose, melobiose, and sucrose.

According to especially preferred embodiments of the present invention the sugar is sucrose.

The admixture of the present invention may be provided as a mono-component admixture or as a multi-component, especially a two-component admixture. A mono-component admixture contains all ingredients of the admixture in one container. A suitable container can be a water-soluble bag, for example a bag made from polyvinyl alcohol. This has the advantage, that the packaging must not be removed. The admixture can be added to the non-hardened cement compositions, especially returned concrete, while still packaged and together with the packaging. A multi-component admixture contains the ingredients of the admixture in multiple, preferably in two, spatially separated containers. A mono-component admixture has the advantage that all ingredients are premixed in the correct quantities and that no dosage errors may occur. A multi-component, especially two-component, composition has the advantage that a ratio of individual components may be easily adjusted as a response to specific requirements.

It has been found that an admixture of the present invention is especially effective with cements of various composition. In particular, an admixture of the present invention is effective with Portland cements having a high content of C₃A (tricalcium aluminate, 3 CaO _{•} Al₂O₃). A high content of C₃A in this context is a content of not less than 4 w%, preferably not less than 7 w%, especially not less than 11 w%, relative to the total dry weight of cement. An upper limit can be 20 w%. Thus, C₃A might be contained in a cement in amounts of 4 - 20 w%, preferably 7 - 20 w%, especially 11 - 20 w%, relative to the total dry weight of cement. Admixtures which are not according to the present invention are less efficient when such amounts of C₃A are present.

### FIGURES

FIG. 1 FIG. 1 shows solid granules obtained in a method as described for example 1-2. Granules of this type could easily be crushed as described in Example 1. Result of crushing is shown to the left of FIG. 1. Results as shown in FIG. 1 are rated with “1” for “compactness” of granules and “1” for “breakability” of granules.

FIG. 2 FIG. 2 shows solid granules obtained in a method as described for example 2-3. Granules of this type could be crushed as described in Example 1. Result of crushing is shown to the left of FIG. 2. Results as shown in FIG. 2 are rated with “2” for “compactness” of granules and “2” for “breakability” of granules.

FIG. 3 FIG. 3 shows solid granules obtained in a method as described for example 3-7. Granules of this type could hardly be crushed as described in Example 1. Result of crushing is shown to the left of FIG. 3. Results as shown in FIG. 3 are rated with “3” for “compactness” of granules and “3” for “breakability” of granules.

FIG. 4 FIG. 4 shows solid granules obtained in a method as described for example 2-4. Granules of this type could not be crushed as described in Example 1. Result of crushing is shown to the left of FIG. 4. Results as shown in FIG. 4 are rated with “c” for “compactness” of granules and “not measurable” for “breakability” of granules.

FIG. 5 FIG. 5 shows a pile of solid granules discharged into a storage facility. Solid granules were prepared as described in example F1 (Capitol) of table 7.

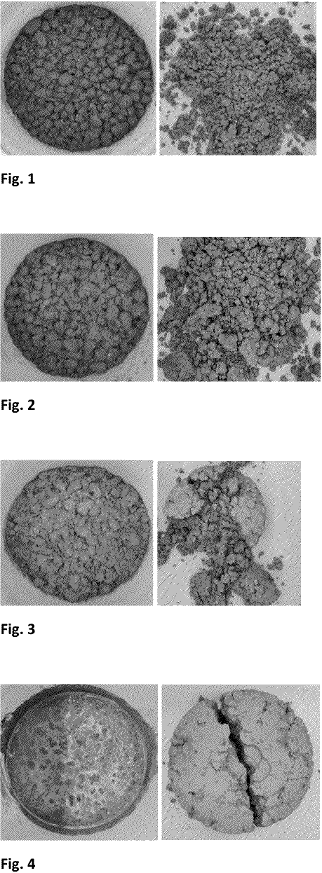

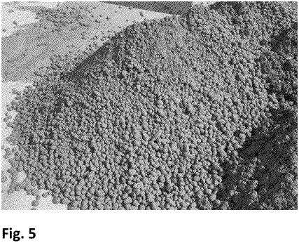

The following examples will provide the skilled person with further embodiments of the present invention. They are not meant to limit the scope of this invention.

### EXAMPLES

The following raw materials were used:
Mod starch: modified starch; starch grafted with acrylic acid potassium salt and acrylamide (CAS 119131-19-0).
Starch: potato starch, not modified
Cellulose: Carboxymethyl cellulose (Mw 50,000 g/mol)
Sucrose: Sigma Aldrich; >99.5% purity
Glucose: D-(+)-glucose; Sigma-Aldrich; >99% purity
Gluconate: sodium D-gluconate; Sigma-Aldrich; >99% purity
Citric acid: Sigma Aldrich; >99.5% purity
Rice husk: Pillowganic; Horticulture Garden

The following admixtures F1 - F31 were prepared by mixing the ingredients in following table 1 until visually homogeneous powders were obtained.

TABLE 1

admixtures prepared (all numbers in g)

| | A1 | A2 | A3 | A4 | A5 | A6 | A7 | A8 | A9 |
|---|---|---|---|---|---|---|---|---|---|
| Mod Starch | 100 | | | 70 | 70 | 75 | 80 | | |
| Starch | | | 70 | | | | | | |
| Cellulose | | | | | | | | 75 | 77 |
| Sucrose | | 100 | 30 | | 30 | 25 | 20 | 25 | 23 |
| Glucose | | | | 30 | | | | | |

TABLE 1 continued

| | A10 | A11 | A12 | A13 | A14 | A15 | A16 | A17 |
|---|---|---|---|---|---|---|---|---|
| Mod Starch | 75 | 75 | 75 | | | | 75 | |
| Cellulose | | | | 75 | 67 | 75 | | 75 |
| Sucrose | | | | | | | 18 | 18 |
| Gluconate | 25 | | | 25 | | | | |
| Citric acid | | 25 | | | 33 | | | |
| SHMP | | | 25 | | | 25 | | |
| Rice husk | | | | | | | 7 | 7 |

Portland cement Type I (ASTM 150-00) with the following compositions were used:

TABLE 2

phase composition of cements (in w% rel to dry cement weight)

| | | C3S | C2S | C3A | C4AF |
|---|---|---|---|---|---|
| Cement 0 | Holcim USA | n.m. | n.m. | n.m. | n.m. |
| Cement 1 | LafargeHolcim, Whitehall | 48 | 17 | 11 | 8 |
| Cement 2 | CalPortland, Mojave | 57 | 15 | 4 | 11 |
| Cement 3 | Lehigh Cement, Nazareth | 57 | 13 | 9 | 8 |
| Cement 4 | Capitol Cement | 60 | 12 | 11 | 6 |

n.m.: not measured

### Example 1

Mortars were prepared by mixing 441.6 g Portland cement Type I (type as indicated in table 3), 358.8 g concrete sand, and 1084.8 g sand #3 on a Hobart mixer for 1 minute. Then 1.73 mL polycarboxylate-based superplasticizer (Sikament 686 supplied by Sika Corp) and water were added to yield a weight ratio of water to cement of 0.5. Mixing on the Hobart mixer was then continued at speed #1 for 3 minutes. The mortars were then mixed by hand with a spatula for 30 seconds. The respective admixture type and amount as indicated in following table 3 was then added. Mixing was then continued at speed #1 for another 2 minutes. Formation of the granules was clearly visible.

Slump was measured on the mortar mixes before addition of the admixture according to standard ASTM C143/C143M using a mini-cone. Therefore, the mini-cone was placed on a non-absorptive base plate and then filled in two layers equal in volume of mortar. Each layer was rodded 25 times with a steel rod, then the top was striked off. The mini-cone was slowly lifted with 3 - 4 seconds and slump measured. The slump is an indicator for similar mixing quality of the mortars prepared. Compactness and breakability of granules was rated according to visual rating scheme (see FIGS. 1 -4). The compactness was judged directly after formation of the solid granules at the end of mixing. For the breakability judgement, the formed block of granules was dried for 24 h at 20-23° C. / 10% r.h. and then intended to be broken up with a hammer in one stroke. A rating of 1 is very good, a rating of 2 is good, a rating of 3 is poor. A rating “c” means that the sample was cured and no granules were formed.

TABLE 3

examples 1-1 to 1-12 (examples 1-3, 1-4, 1-6, 1-7, 1-8, 1-9, 1-10, 1-11 are not according to the present invention

| | | | | | | | | |
|---|---|---|---|---|---|---|---|---|
| Example | 1-1 | 1-2 | 1-3 | 1-4 | 1-5 | 1-6 | 1-7 | 1-8 |
| Admixture | A5 | A6 | A8 | A13 | A7 | A10 | A11 | A12 |
| Cement | 0 | 0 | 0 | 0 | 0 | 0 | 0 | 0 |
| Dosage [kg/m³] | 1.2 | 1.2 | 1.2 | 1.2 | 1.2 | 1.2 | 1.2 | 1.2 |
| Initial slump [cm] | 10 | 9.5 | 9.5 | 10 | n.a. | n.a. | n.a. | n.a. |
| Compactness* | 3 | 1 | 3 | c | c | 3 | 3 | c |
| Breakability** | 2 | 1 | 2 | 3 | 3 | 2 | 2 | n.m. |

n.a.: not available
n.m.: not measurable

TABLE 3 continued

| | | | | |
|---|---|---|---|---|
| Example | 1-9 | 1-10 | 1-11 | 1-12 |
| Admixture | A1 | A2 | A3 | A4 |
| Cement | 4 | 4 | 4 | 4 |
| Dosage [kg/m³] | 1.2 | 1.2 | 1.2 | 1.2 |
| Initial slump [cm] | 10.2 | 10.2 | 10.2 | 10.2 |
| Compactness* | c | dnc | c | 3 |
| Breakability** | n.m. | dnc | 3 | 2 |

dnc: does not coagulate
n.m.: not measurable

A low rating in compactness and breakability is desirable. It is thus apparent from table 3, that admixture A6 performs best.

### Example 2

Concrete was prepared by mixing 22.23 kg sand, 29.8 kg gravel, and 9.23 kg of water on a Concrete Steel-Drum Electric Mixer for 45 seconds. Then, 10.26 kg Portland cement Type I (type as indicated in table 4), were added and mixing continued for 1 minute. Next, 40 mL polycarboxylate-based superplasticizer (Sikament 686 supplied by Sika Corp) and 1.03 kg of water were added to yield a weight ratio of water to cement of 0.5. Mixing was then continued for 3 minutes and 15 seconds. Next, the respective admixture type and amount as indicated in following table 4 was added. Mixing was then continued for another 2 minutes. Formation of the granules was clearly visible.

Slump, compactness, and breakability were measured as described in example 1.

TABLE 4

examples 2-1 to 2-5 (examples 2-3, 2-4, 2-5 are not according to the present invention)

| | | | | | |
|---|---|---|---|---|---|
| Example | 2-1 | 2-2 | 2-3 | 2-4 | 2-5 |
| Admixture | A5 | A6 | A8 | A13 | A14 |
| Cement | Holcim | Holcim | Holcim | Holcim | Holcim |
| Dosage [kg/m³] | 1.2 | 1.2 | 1.2 | 1.2 | 1.2 |
| Initial slump [cm] | 19.7 | 19.7 | 20.3 | 19.7 | 19.1 |
| Compactness* | 3 | 2 | 2 | c | 3 |
| Breakability | n.m. | 1 | 2 | n.m. | n.m. |

n.m.: not measurable

### Example 3

Concrete in example 3 were prepared in the same way as in example 2. For example 3, Portland cement from different suppliers was tested. The Portland cement, type of admixture and admixture dosage is indicated in below tables 5 - 8. Results obtained are also indicated in below table 5 - 8.

TABLE 5

examples 3-1 to 3-3 (example 3-1 is not according to the present invention)

| | | | |
|---|---|---|---|
| Example | 3-1 | 3-2 | 3-3 |
| Additive | A8 | A6 | A16 |
| Cement | 1 | 1 | 1 |
| Dosage [kg/m³] | 1.2 | 1.8 | 1.8 |
| Initial slump [cm] | 21 | 20.3 | 21 |
| Compactness* | 3 | 2 | 2 |
| Breakability | 2 | 2 | 2 |

TABLE 6

examples 3-4 to 3-6 (example 3-4 is not according to the present invention)

| | | | |
|---|---|---|---|
| Example | 3-4 | 3-5 | 3-6 |
| Additive | A8 | A6 | A16 |
| Cement | 2 | 2 | 2 |
| Dosage [kg/m³] | 1.2 | 1.8 | 1.8 |
| Initial slump [cm] | 21 | 21 | 21 |
| Compactness* | 2 | 2 | 2 |
| Breakability | 2 | 2 | 2 |

TABLE 7

examples 3-7 to 3-9 (example 3-7 is not according to the present invention)

| | | | |
|---|---|---|---|
| Example | 3-7 | 3-8 | 3-9 |
| Additive | A8 | A6 | A16 |
| Cement | 3 | 3 | 3 |
| Dosage [kg/m³] | 1.2 | 1.8 | 1.8 |
| Initial slump [cm] | 20.3 | 20.3 | 20.3 |
| Compactness* | 3 | 2 | 3 |
| Breakability | 3 | 1 | 3 |

TABLE 8

examples 3-10 to 3-13 (example 3-10 not according to the present invention)

| | | | | |
|---|---|---|---|---|
| Example | 3-10 | 3-11 | 3-12 | 3-13 |
| Additive | A8 | A6 | A16 | A17 |
| Cement | 4 | 4 | 4 | 4 |
| Dosage [kg/m³] | 1.8 | 1.8 | 1.8 | 1.8 |
| Initial slump [cm] | 19.7 | 19.7 | 20.3 | 20.3 |
| Compactness* | c | 1 | 2 | 3 |
| Breakability | 3 | 1 | 2 | n.m. |

1. A method for the treatment of non-hardened cement compositions, especially returned concrete, said method comprising the steps of:
a) providing a non-hardened cement compositions,
b) providing an admixture which comprises a modified starch and a sugar,
c) mixing the non-hardened cement compositions and the admixture to form a coagulated material,
d) discharging the coagulated material obtained under c) into a storage facility,
e) drying the coagulated material to form solid granules, and
f) optionally separating the dried, solid granules into fractions of different particle size.

2. A method according to claim 1, wherein the admixture provided in step b) essentially consists of a modified starch and a sugar.

3. A method according to claim 1, wherein the admixture essentially consists of 70 - 80 w% of modified starch and 20 - 30 w% of a sugar.

4. A method according to claim 1, wherein the modified starch is a copolymer of starch grafted with acrylic acid and acrylamide.

5. A method according to claim 1, wherein the sugar is sucrose.

6. A method according to claim 1, wherein it additionally comprises a step of crushing and/or grinding the solid granules.

7. A method according to claim 6, wherein the crushing and/or grinding is done under an atmosphere of CO₂.

8. A concrete or mortar mixture comprising at least one cement and aggregates, wherein at least 30 w% of the total weight of aggregates are solid granules obtained in a method as described in claim 1.

9. An admixture for use in a method for the treatment of non-hardened cement compositions, the admixture comprising
a) a modified starch, and
b) a sugar.

10. An admixture according to claim 9, wherein it consists of a modified starch and a sugar.

11. An admixture according to claim 9, wherein it consists of 70 - 80 w% of modified starch and 20 - 30 w% of a sugar.

12. An admixture according to claim 9, wherein the modified starch is a graft copolymer of starch with a copolymer of starch grafted with acrylic acid and acrylamide.

13. An admixture according to claim 9, wherein the sugar is sucrose.

14. An admixture according to claim 9, wherein it is a monocomponent admixture.

15. An admixture according to claim 9, wherein it is a multicomponent admixture.
